(19) United States
(12) Patent Application Publication
(10) Pub. No.: US 2023/0316093 A1
(43) Pub. Date: Oct. 5, 2023

(54) CONTEXTUAL DATA ANALYSIS IN COMPUTING SYSTEMS

(71) Applicant: Microsoft Technology Licensing, LLC, Redmond, WA (US)

(72) Inventors: Ananthatejas Raghavan, San Jose, CA (US); Anjaneya Malpani, Bellevue, WA (US); Joseph Robert Forsman, Norman, OK (US); Jagadeesh Virupaksha Huliyar, Redmond, WA (US); Umashree Narayanaswamy, Redmond, WA (US); Samuel Spring Rackey, Seattle, WA (US)

(21) Appl. No.: 17/708,157

(22) Filed: Mar. 30, 2022

(51) Int. Cl. G06N 5/00; H04L 41/14

(52) U.S. Cl. CPC G06N 5/003; H04L 41/14

(57) ABSTRACT

Techniques of contextual data analysis in distributed computing systems are disclosed herein. In one example, upon receiving operational data and attribute data representing attributes of multiple entities in the distributed computing system, a decision tree is generated based on the received operational and attribute data via machine learning. The decision tree has a root and multiple branches each representing a set of the attributes in the attribute data and a corresponding probability value representing a likelihood that one of the multiple components with the set of the attributes would be associated with an event in the distributed computing system. The multiple branches can then be parsed to identify a common subset of the attributes of the multiple components as most closely related to an occurrence of the event in the distributed computing system.

### BACKGROUND

A system performance monitor in a computing system can provide operational measurements that allow end users, administrators, or organizations to gauge and evaluate performance of the computing system. For example, a system performance monitor can monitor operations of a computer network in the computing system and provide levels of percentage of dropped packets, network latency, average number of retries, or other parameters of the computer network. Based on the provided operational parameters, a network administrator can modify configurations or perform other suitable actions to address issues or improve performance in the computer network.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Though system performance monitors can provide operational parameters that indicate issues in a computing system, system performance monitors typically do not provide indications of which attribute(s) of the computing system may be manipulated to rectify or ameliorate the indicated issues. For instance, a system performance monitor can provide data indicating that a percentage of dropped packets in a computer network (or a portion thereof) has exceeded a threshold. The system performance monitor, however, does not provide which attribute, e.g., network topology, virtual network configuration, etc., that has contributed to the high percentage of dropped packets. As such, a network administrator may not readily diagnose and address any reported issues, thus resulting in low system performance and undesirable system downtime.

Several embodiments of the disclosed technology can address at least some of the foregoing drawbacks by implementing a data analyzer that is configured to perform contextual data analysis of monitored operational data in a computing system. The data analyzer can be an integral part of a system performance monitor, a standalone application, or can have other suitable configurations. In certain implementations, the data analyzer can be configured to receive operational data in a computing system as well as attribute data of components in the computing system. For instance, using a computer network as an example, the data analyzer can be configured to retrieve or otherwise receive operational data as well as attribute data of components in the computer network. Example operational data can include percentage of dropped packets, network latency, number of retries, or other suitable parameters at each component in the computer network. Example attribute data can include data representing, for instance, geographic locations, network connectivity, port configuration, Software Defined Network (SDN) configuration of routers, switches, gateways, load balancers, firewalls, or other suitable components in the computer network.

Upon receiving the operating and attribute data, a machine learning engine of the data analyzer can be configured to generate a decision tree based on the operational data and the attribute data to predict a probability of being associated with a network event, such as high percentage of dropped packets, for different attributes of the components in the computer network. For example, the machine learning engine can be configured to utilize a “neural network” or “artificial neural network” to “learn” or progressively improve performance of tasks by studying known examples of operational data. A neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. The artificial neurons can be organized in layers. Different layers may perform different kinds of transformations on respective inputs. Signals typically travel from an input layer to an output layer, possibly after traversing one or more intermediate layers.

As such, by using a neural network, the machine learning engine can provide a set of weights between pairs of neurons corresponding to contribution of sets of one or more attributes of network components in the computer network to an occurrence of the network event. For example, attribute A can be associated with a probability of 10% of having the network event while a combination of attributes A, B, and C is associated with a probability of 20% of having the network event. In other examples, various other combinations of attribute A, B, or C can each be associated with a corresponding probability value.

Based on the determined weights, the machine learning engine can provide a decision tree that includes a root and multiple branches at one or more levels each representing a set of the attributes and a corresponding probability that a network component having the set of attributes would experience a network event, such as a high percentage of dropped packets. As used herein, a decision tree generally refers to a data structure having a root that connects to one or more branches distinct from one another by a value of at least one of the attributes. For example, a first branch can be configured to represent network components in a first geographic location while a second branch can be configured to represent network components in a second geographic location.

Upon obtaining the decision tree, a parser of the data analyzer can be configured to parse the branches of the decision tree to identify a subset of the attributes that most closely correlate to the network event. The subset of the attributes can provide a context for addressing the network event in the computer network. For instance, a first branch can indicate that a set of attributes A, B, C, and D correspond to a probability of 40% of having the network event. A second branch can indicate that another set of attributes A, B, D, and E has a probability of 30% of having the network event. As such, the parser can be configured to determine that a common subset of the attributes from both the first and second branches, i.e., A, B, and D would have a probability of 70% of having the network event. In certain embodiments, the foregoing parsing and identifying operations can be performed iteratively through all or at least some of the branches until a threshold number (e.g., three) of attributes in the common subset are obtained. In other embodiments, the foregoing iterative parsing and identifying operations can be performed until a threshold probability or other suitable criteria are satisfied.

Several embodiments of the disclosed technology can thus provide “insights” into the operational and attribute data in the computing system. By analyzing attributes of the network components and corresponding probability of having a network event, sets of the attributes that correlate to the network event can be identified. Subsequently, the identified sets of attributes can be parsed and aggregated to identify one or more common subsets of attributes that are most closely related to an occurrence of the network event. As such, based on the one or more common subsets, a network administrator can modify configurations of network components in the computing system or perform other suitable actions to at least reduce or eliminate the occurrence of the network event.

Though the data analyzer is described above in the context of operating a computer network, in other implementations, aspects of the disclosed technology can also be applied to analyze other suitable types of data. For example, performance data of workers (e.g., an amount of overtime) and attributes of the workers (e.g., department, office, manager, discipline, job category, etc.) can be received and processed by the data analyzer as described above to identify one or more common subsets of the attributes of the workers that a supervisor may act to influence the future performance of the workers, such as overtime hours. In other examples, aspects of the disclosed technology can be applied to productivity or other suitable types of data.

### BRIEF DESCRIPTION OF THE DRAWINGS

FIG. 1 is a schematic diagram illustrating a distributed computing system implementing contextual data analysis in accordance with embodiments of the disclosed technology.

FIG. 2 is a schematic diagram illustrating certain hardware/software components of the distributed computing system of FIG. 1 in accordance with embodiments of the disclosed technology.

FIG. 3 is a schematic diagram illustrating an example data analyzer suitable for the distributed computing system in accordance with embodiments of the disclosed technology.

FIGS. 4A and 4B are flowcharts illustrating various processes for contextual data analysis in a distributed computing system in accordance with embodiments of the disclosed technology.

FIG. 5 is a computing device suitable for certain components of the distributed computing system in FIG. 1.

### DETAILED DESCRIPTION

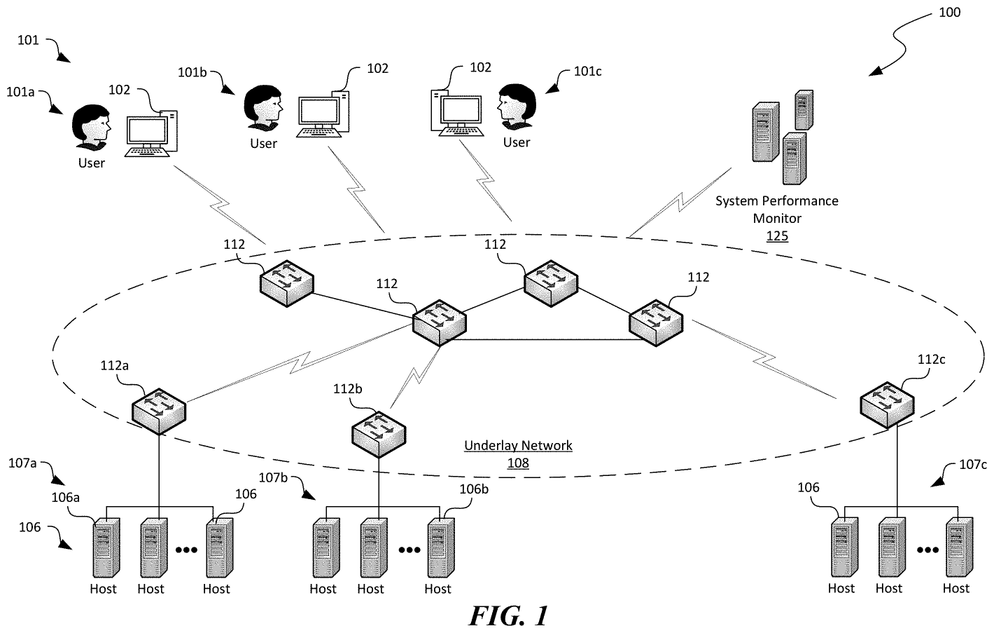

Certain embodiments of systems, devices, components, modules, routines, data structures, and processes for contextual data analysis in distributed computing systems are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-5.

As used herein, the term “distributed computing system” generally refers to an interconnected computer system having multiple network nodes that interconnect a plurality of servers or hosts to one another and/or to external networks (e.g., the Internet). The term “network node” generally refers to a physical network device. Example network nodes include routers, switches, hubs, bridges, load balancers, security gateways, or firewalls. A “host” generally refers to a physical computing device. In certain embodiments, a host can be configured to implement, for instance, one or more virtual machines, virtual switches, or other suitable virtualized components. For example, a host can include a server having a hypervisor configured to support one or more virtual machines, virtual switches, or other suitable types of virtual components. In other embodiments, a host can be configured to execute suitable applications directly on top of an operating system.

A computer network can be conceptually divided into an overlay network implemented over an underlay network in certain implementations. An “overlay network” generally refers to an abstracted network implemented over and operating on top of an underlay network. The underlay network can include multiple physical network nodes interconnected with one another. An overlay network can include one or more virtual networks. A “virtual network” generally refers to an abstraction of a portion of the underlay network in the overlay network. A virtual network can include one or more virtual end points referred to as “tenant sites” individually used by a user or “tenant” to access the virtual network and associated computing, storage, or other suitable resources. A tenant site can host one or more tenant end points (“TEPs”), for example, virtual machines. The virtual networks can interconnect multiple TEPs on different hosts. Virtual network nodes in the overlay network can be connected to one another by virtual links individually corresponding to one or more network routes along one or more physical network nodes in the underlay network. In other implementations, a computer network can only include the underlay network.

System performance monitors can typically provide operational parameters that indicate issues in a computing system. However, system performance monitors in general do not provide indications of which attribute(s) of the computing system may be manipulated to rectify or ameliorate the indicated issues. As such, a network administrator may not readily diagnose and address any reported issues. Several embodiments of the disclosed technology can address at least some of the foregoing drawbacks by implementing a data analyzer that is configured to perform contextual data analysis of monitored operational data in a computing system utilizing machine learning, as described in more detail below with reference to FIGS. 1-5.

FIG. 1 is a schematic diagram illustrating a distributed computing system 100 implementing contextual data analysis in accordance with embodiments of the disclosed technology. As shown in FIG. 1, the distributed computing system 100 can include an underlay network 108 interconnecting multiple hosts 106, client devices 102 associated with corresponding users 101, and a system performance monitor 125 operatively coupled to one another. Even though particular components of the distributed computing system 100 are shown in FIG. 1, in other embodiments, the distributed computing system 100 can also include additional and/or different components or arrangements. For example, in certain embodiments, the distributed computing system 100 can also include network storage devices, additional hosts, and/or other suitable components (not shown) in other suitable configurations.

As shown in FIG. 1, the underlay network 108 can include one or more network nodes 112 that interconnect the multiple hosts 106 and the client device 102 of the users 101. In certain embodiments, the hosts 106 can be organized into racks, action zones, groups, sets, or other suitable divisions. For example, as shown in FIG. 1, the hosts 106 are grouped into three host sets identified individually as first, second, and third host sets 107a-107c. Each of the host sets 107a-107c is operatively coupled to a corresponding network nodes 112a-112c, respectively, which are commonly referred to as “top-of-rack” network nodes or “TORs.” The TORs 112a-112c can then be operatively coupled to additional network nodes 112 to form a computer network in a hierarchical, flat, mesh, or other suitable types of topologies. The underlay network 108 can allow communications among hosts 106, the system performance monitor 125, and the users 101. In other embodiments, the multiple host sets 107a-107c may share a single network node 112 or can have other suitable arrangements.

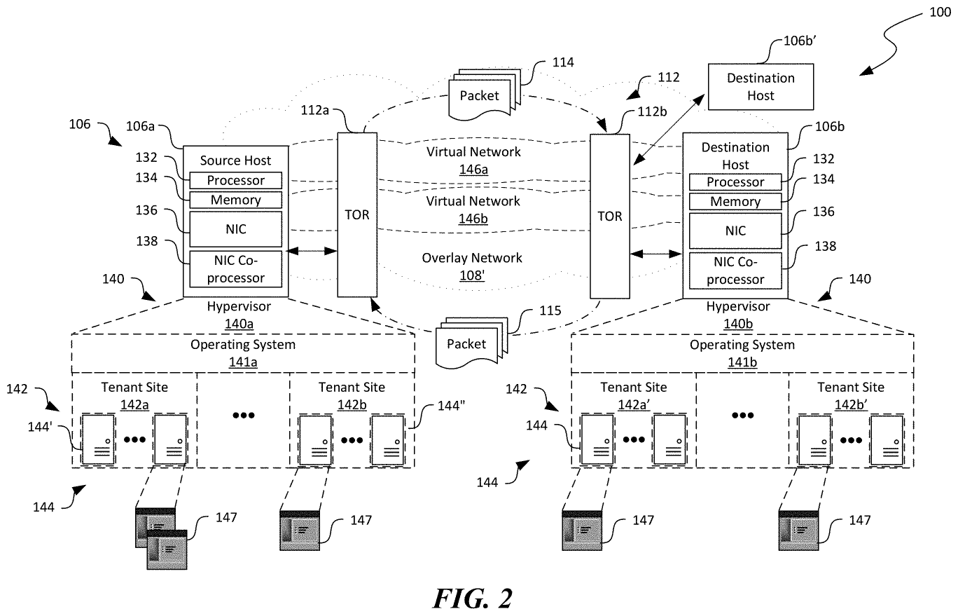

The hosts 106 can individually be configured to provide computing, storage, and/or other suitable cloud or other types of computing services to the users 101. For example, as described in more detail below with reference to FIG. 2, one of the hosts 106 can initiate and maintain one or more virtual machines 144 (shown in FIG. 2) or containers (not shown) upon requests from the users 101. The users 101 can then utilize the provided virtual machines 144 or containers to perform database, computation, communications, and/or other suitable tasks. In certain embodiments, one of the hosts 106 can provide virtual machines 144 for multiple users 101. For example, the host 106a can host three virtual machines 144 individually corresponding to each of the users 101a-101c. In other embodiments, multiple hosts 106 can host virtual machines 144 for the users 101a-101c.

The client devices 102 can each include a computing device that facilitates the users 101 to access computing services provided by the hosts 106 via the underlay network 108. In the illustrated embodiment, the client devices 102 individually include a desktop computer. In other embodiments, the client devices 102 can also include laptop computers, tablet computers, smartphones, or other suitable computing devices. Though three users 101 are shown in FIG. 1 for illustration purposes, in other embodiments, the distributed computing system 100 can facilitate any suitable numbers of users 101 to access cloud or other suitable types of computing services provided by the hosts 106 in the distributed computing system 100.

The system performance monitor 125 can be configured to monitor operational parameters and performance of the distributed computing system 100. For example, the system performance monitor 125 can be configured to monitor and collect operational parameters related to performance of the underlay network 108. Example operational parameters can include numbers of packets dropped, network latency, numbers of retries, or other suitable parameters of the underlay network 108. As described in more detail below, the system performance monitor 125 can also include or have access to a data analyzer that is configured to identify one or more attributers of the network nodes 112 most closely related to certain network events, such as high network latency. In the illustrated implementation, the system performance monitor 125 is shown as an independent hardware/software component of the distributed computing system 100. In other embodiments, the system performance monitor 125 can also be a datacenter controller, a fabric controller, or other suitable types of controllers or a component thereof implemented as a computing service on one or more of the hosts 106.

FIG. 2 is a schematic diagram illustrating details of certain hardware and software components of the distributed computing system 100 in accordance with embodiments of the disclosed technology. In particular, FIG. 2 illustrates an overlay network 108′ that can be implemented on the underlay network 108 in FIG. 1. Though particular configuration of the overlay network 108′ is shown in FIG. 2, In other embodiments, the overlay network 108′ can also be configured in other suitable ways. In FIG. 2, only certain components of the underlay network 108 of FIG. 1 are shown for clarity.

In FIG. 2 and in other Figures herein, individual software components, objects, classes, modules, and routines may be a computer program, procedure, or process written as source code in C, C++, C #, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2, the source host 106a and the destination hosts 106b and 106b′ (only the destination hosts 106b is shown with detail components) can each include a processor 132, a memory 134, a network interface card 136, and a NIC co-processor 138 operatively coupled to one another. In other embodiments, the hosts 106 can also include input/output devices configured to accept input from and provide output to an operator and/or an automated software controller (not shown), or other suitable types of hardware components.

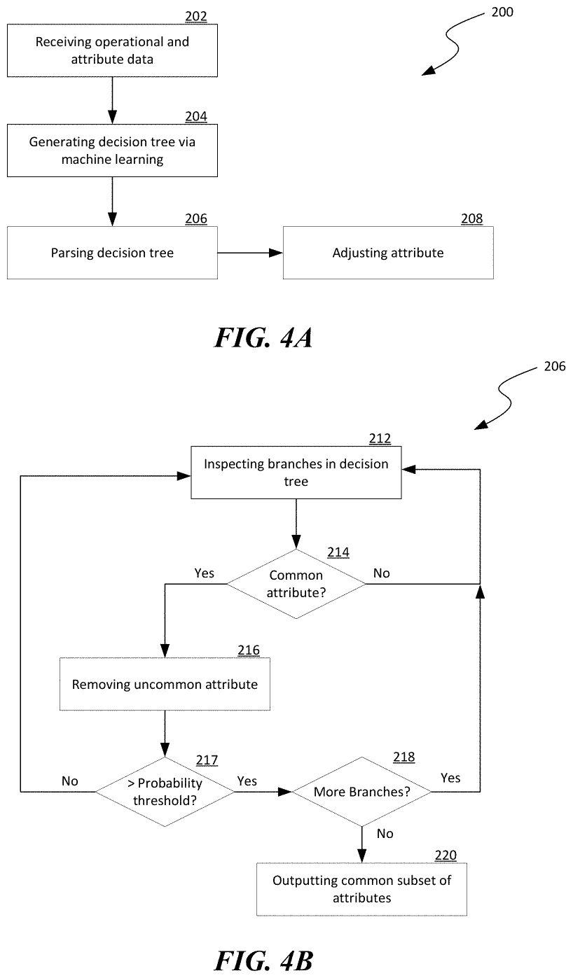

The processor 132 can include a microprocessor, caches, and/or other suitable logic devices. The memory 134 can include volatile and/or nonvolatile media (e.g., ROM; RAM, magnetic disk storage media; optical storage media; flash memory devices, and/or other suitable storage media) and/or other types of computer-readable storage media configured to store data received from, as well as instructions for, the processor 132 (e.g., instructions for performing the methods discussed below with reference to FIGS. 4A and 4B). Though only one processor 132 and one memory 134 are shown in the individual hosts 106 for illustration in FIG. 2, in other embodiments, the individual hosts 106 can include two, six, eight, or any other suitable number of processors 132 and/or memories 134.

The source host 106a and the destination host 106b can individually contain instructions in the memory 134 executable by the processors 132 to cause the individual processors 132 to provide a hypervisor 140 (identified individually as first and second hypervisors 140a and 140b) and an operating system 141 (identified individually as first and second operating systems 141a and 141b). Even though the hypervisor 140 and the operating system 141 are shown as separate components, in other embodiments, the hypervisor 140 can operate on top of the operating system 141 executing on the hosts 106 or a firmware component of the hosts 106.

The hypervisors 140 can individually be configured to generate, monitor, terminate, and/or otherwise manage one or more virtual machines 144 organized into tenant sites 142. For example, as shown in FIG. 2, the source host 106a can provide a first hypervisor 140a that manages first and second tenant sites 142a and 142b, respectively. The destination host 106b can provide a second hypervisor 140b that manages first and second tenant sites 142a′ and 142b′, respectively. The hypervisors 140 are individually shown in FIG. 2 as a software component. However, in other embodiments, the hypervisors 140 can be firmware and/or hardware components. The tenant sites 142 can each include multiple virtual machines 144 for a particular tenant (not shown). For example, the source host 106a and the destination host 106b can both host the tenant site 142a and 142a′ for a first tenant 101a (FIG. 1). The source host 106a and the destination host 106b can both host the tenant site 142b and 142b′ for a second tenant 101b (FIG. 1). Each virtual machine 144 can be executing a corresponding operating system, middleware, and/or applications.

Also shown in FIG. 2, the distributed computing system 100 can include an overlay network 108′ having one or more virtual networks 146 that interconnect the tenant sites 142a and 142b across multiple hosts 106. For example, a first virtual network 142a interconnects the first tenant sites 142a and 142a′ at the source host 106a and the destination host 106b. A second virtual network 146b interconnects the second tenant sites 142b and 142b′ at the source host 106a and the destination host 106b. Even though a single virtual network 146 is shown as corresponding to one tenant site 142, in other embodiments, multiple virtual networks 146 (not shown) may be configured to correspond to a single tenant site 146.

The virtual machines 144 can be configured to execute one or more applications 147 to provide suitable cloud or other suitable types of computing services to the users 101 (FIG. 1). For example, the source host 106a can execute an application 147 that is configured to provide a computing service that monitors stock trading and distribute stock price data to multiple users 101 subscribing to the computing service. The virtual machines 144 on the virtual networks 146 can also communicate with one another via the underlay network 108 (FIG. 1) even though the virtual machines 144 are located on different hosts 106.

Communications of each of the virtual networks 146 can be isolated from other virtual networks 146. In certain embodiments, communications can be allowed to cross from one virtual network 146 to another through a security gateway or otherwise in a controlled fashion. A virtual network address can correspond to one of the virtual machines 144 in a particular virtual network 146. Thus, different virtual networks 146 can use one or more virtual network addresses that are the same. Example virtual network addresses can include IP addresses, MAC addresses, and/or other suitable addresses. To facilitate communications among the virtual machines 144, virtual switches (not shown) can be configured to switch or filter packets 114 directed to different virtual machines 144 via the network interface card 136 and facilitated by the NIC co-processor 138.

As shown in FIG. 2, to facilitate communications with one another or with external devices, the individual hosts 106 can also include a network interface card (“NIC”) 136 for interfacing with a computer network (e.g., the underlay network 108 of FIG. 1). A NIC 136 can include a network adapter, a LAN adapter, a physical network interface, or other suitable hardware circuitry and/or firmware to enable communications between hosts 106 by transmitting/receiving data (e.g., as packets) via a network medium (e.g., fiber optic) according to Ethernet, Fibre Channel, Wi-Fi, or other suitable physical and/or data link layer standards. During operation, the NIC 136 can facilitate communications to/from suitable software components executing on the hosts 106. Example software components can include the virtual switches 141, the virtual machines 144, applications 147 executing on the virtual machines 144, the hypervisors 140, or other suitable types of components.

In certain implementations, a NIC co-processor 138 can be interconnected to and/or integrated with the NIC 136 to facilitate network traffic operations for enforcing communications security, performing network virtualization, translating network addresses, maintaining/limiting a communication flow state, or performing other suitable functions. In certain implementations, the NIC co-processor 138 can include a Field-Programmable Gate Array (“FPGA”) integrated with the NIC 136.

An FPGA can include an array of logic circuits and a hierarchy of reconfigurable interconnects that allow the logic circuits to be “wired together” like logic gates by a user after manufacturing. As such, a user 101 can configure logic blocks in FPGAs to perform complex combinational functions, or merely simple logic operations to synthetize equivalent functionality executable in hardware at much faster speeds than in software. In the illustrated embodiment, the NIC co-processor 138 has one interface communicatively coupled to the NIC 136 and another coupled to a network switch (e.g., a Top-of-Rack or “TOR” switch) at the other. In other embodiments, the NIC co-processor 138 can also include an Application Specific Integrated Circuit (“ASIC”), a microprocessor, or other suitable hardware circuitry.

In operation, the processor 132 and/or a user 101 (FIG. 1) can configure logic circuits in the NIC co-processor 138 to perform complex combinational functions or simple logic operations to synthetize equivalent functionality executable in hardware at much faster speeds than in software. For example, the NIC co-processor 138 can be configured to process inbound/outbound packets for individual flows according to configured policies or rules contained in a flow table such as a MAT. The flow table can contain data representing processing actions corresponding to each flow for enabling private virtual networks with customer supplied address spaces, scalable load balancers, security groups and Access Control Lists (“ACLs”), virtual routing tables, bandwidth metering, Quality of Service (“QoS”), etc.

As such, once the NIC co-processor 138 identifies an inbound/outbound packet as belonging to a particular flow, the NIC co-processor 138 can apply one or more corresponding policies in the flow table before forwarding the processed packet to the NIC 136 or TOR 112. For example, as shown in FIG. 2, the application 147, the virtual machine 144, and/or other suitable software components on the source host 106a can generate an outbound packet 114 destined to, for instance, other applications 147 at the destination hosts 106b and 106b′. The NIC 136 at the source host 106a can forward the generated packet 114 to the NIC co-processor 138 for processing according to certain policies in a flow table. Once processed, the NIC co-processor 138 can forward the outbound packet 114 to the first TOR 112a, which in turn forwards the packet to the second TOR 112b via the overlay/underlay network 108 and 108′.

The second TOR 112b can then forward the packet 114 to the NIC co-processor 138 at the destination hosts 106b and 106b′ to be processed according to other policies in another flow table at the destination hosts 106b and 106b′. If the NIC co-processor 138 cannot identify a packet as belonging to any flow, the NIC co-processor 138 can forward the packet to the processor 132 via the NIC 136 for exception processing. In another example, when the first TOR 112a receives an inbound packet 115, for instance, from the destination host 106b via the second TOR 112b, the first TOR 112a can forward the packet 115 to the NIC co-processor 138 to be processed according to a policy associated with a flow of the packet 115. The NIC co-processor 138 can then forward the processed packet 115 to the NIC 136 to be forwarded to, for instance, the application 147 or the virtual machine 144.

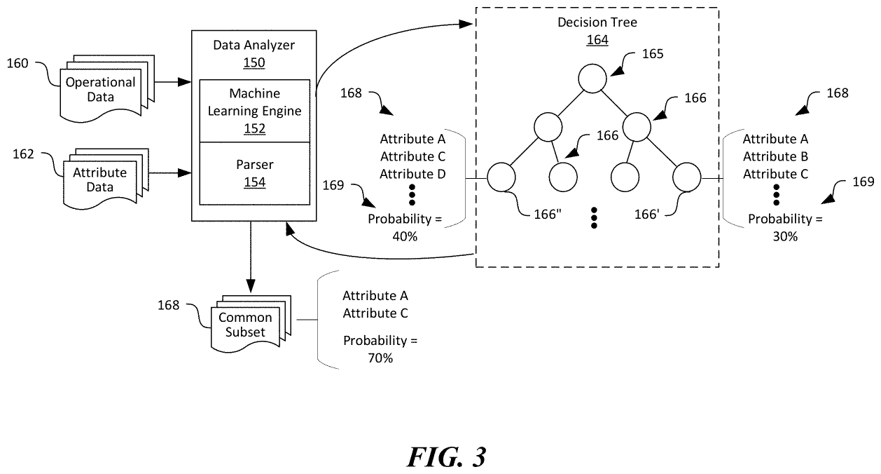

FIG. 3 is a schematic diagram illustrating an example data analyzer 150 suitable for the distributed computing system 100 in accordance with embodiments of the disclosed technology. The data analyzer 150 can be an integral part of the system performance monitor 125 in FIG. 1, a standalone application, or can have other suitable configurations. As shown in FIG. 3, the data analyzer 150 includes a machine learning engine 152 and a parser 154 operatively coupled to each other. Though particular components of the data analyzer 150 are shown in FIG. 3 for illustration purposes, in other embodiments, the data analyzer 150 can also include an interface, calculation, database, or other suitable types of components in addition to or in lieu of those shown in FIG. 3.

In certain implementations, the machine learning engine 152 of the data analyzer 150 can be configured to receive certain operational data 160 in the distributed computing system 100 as well as attribute data 162 of components in the distributed computing system 100. For instance, the machine learning engine 152 of the data analyzer 150 can be configured to retrieve or otherwise receive operational data 160 as well as attribute data 162 of network nodes 112 (FIG. 1) in the underlay network 108. Example operational data 160 can include percentage of dropped packets, network latency, number of retries, or other suitable parameters at each network node 112 in the underlay network 108. Example attribute data 162 can include data representing, for instance, geographic locations, network connectivity, port configuration, Software Defined Network (SDN) configuration of routers, switches, gateways, load balancers, firewalls, or other suitable types of network nodes 112 in the underlay network 108.

Upon receiving the operational data 160 and the attribute data 162, the machine learning engine 152 of the data analyzer 150 can be configured to generate a decision tree 164 based on the operational data 160 and the attribute data 162 to predict a probability of being associated with a network event for different attributes of the network nodes 112, such as high percentage of dropped packets. For example, the machine learning engine 152 can be configured to utilize a “neural network” or “artificial neural network” to “learn” or progressively improve performance of tasks by studying known examples of operational data 160. A neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. The artificial neurons can be organized in layers. Different layers may perform different kinds of transformations on respective inputs. Signals typically travel from an input layer to an output layer, possibly after traversing one or more intermediate layers.

As such, by using a neural network, the machine learning engine 152 can provide a set of weights between pairs of neurons corresponding to contribution of sets of one or more attributes of network components in the computer network to an occurrence of the network event. For example, attribute A can be associated with a probability of 10% of having the network event while a combination of attributes A, B, and C is associated with a probability of 20% of having the network event. In other examples, various other combinations of attribute A, B, C, or other attributes can each be associated with a corresponding probability value.

Based on the determined weights, the machine learning engine 152 can provide the decision tree 164 that includes a root 165 and multiple branches 166 at one or more levels each representing a set of the attributes and a corresponding probability that a network node 112 having the set of attributes would experience the network event, such as a high percentage of dropped packets. As used herein, a decision tree 164 generally refers to a data structure having a root that connects to one or more branches distinct from one another by a value of at least one of the attributes. For example, a first branch 166′ can be configured to represent network nodes 112 with attributes A, B, and C while a second branch 166″ can be configured to represent network nodes with attributes A, C, and D. A decision tree 164 can be constructed by populating branches on the root or a previous level of branches based on different values of one of the attributes. For example, multiple branches on the root of the decision tree based on different values (e.g., “North America,” “Europe,” “Asian”) of one of the multiple attributes (e.g., geographic location).

Upon obtaining the decision tree 164, the parser 154 of the data analyzer 150 can be configured to parse the branches 166 of the decision tree 164 to identify a subset of the attributes that most closely correlate to the network event. The subset of the attributes can provide a context for addressing the network event in the underlay network 108. For instance, as shown in FIG. 3, the first branch 166′ can indicate that a first set of attributes A, B, and C correspond to a probability of 30% of having the network event. The second branch 166″ can indicate that a second set of attributes A, C, and D has a probability of 40% of having the network event. As such, the parser 154 can be configured to determine that a common subset 168 of the attributes from both the first and second branches 166′ and 166″, i.e., A and C would have a probability of 70% of having the network event. Thus, the parser 154 can be configured to output the common subset 168 indicating that network nodes 112 having the common subset 168 of attributes would have a 70% chance of experiencing the network event. In certain embodiments, the foregoing parsing and identifying operations can be performed iteratively through all or at least some of the branches until a threshold number (e.g., four, three, or two) of attributes in the common subset 168 is obtained. In other embodiments, the foregoing iterative parsing and identifying operations can be performed until a threshold probability or other suitable criteria are satisfied.

Several embodiments of the disclosed technology can thus provide “insights” into the operational data 160 and the attribute data 162 in the distributed computing system 100. By analyzing attributes of the network nodes 112 and corresponding probability of having a network event, sets of the attributes that correlate to the network event can be identified. Subsequently, the identified sets of attributes can be parsed and aggregated to identify one or more common subset 168 of attributes that are most closely related to an occurrence of the network event. As such, based on the one or more common subset 168, a network administrator can modify configurations of the network nodes in the distributed computing system 100 or perform other suitable actions to at least reduce or eliminate the occurrence of the network event.

Though the data analyzer 150 is described above in the context of operating a underlay network 108, in other implementations, aspects of the disclosed technology can also be applied to analyze other suitable types of data. For example, performance data of workers (e.g., an amount of overtime) and attributes of the workers (e.g., department, office, manager, discipline, job category, etc.) can be received and processed by the data analyzer 150 as described above to identify one or more common subset 168 of the attributes of the workers that a supervisor may act to influence the future performance of the workers, such as overtime hours. In other examples, aspects of the disclosed technology can be applied to productivity or other suitable types of data.

FIGS. 4A and 4B are flowcharts illustrating processes for implementing contextual data analysis in accordance with embodiments of the disclosed technology. Though the processes are described below considering the distributed computing system 100 of FIGS. 1-3, in other embodiments, the processes can also be performed in other computing systems with similar or different components.

As shown in FIG. 4A, a process 200 can include receiving operational and attribute data at stage 202. In certain implementations, the operational and attribute data can be retrieved from, for example, a database accessible by a system performance monitor. In other implementations, such data can be continuously, periodically, or in other suitable manners provided to the data analyzer 150 in FIG. 3. Upon receiving the operational and attribute data, the process 200 can also include generating a decision tree based on the operational and attribute data via machine learning at stage 204. In certain embodiments, the machine learning can be tuned to determine sets of attributes of components and corresponding probability values that correlate the sets of attributes to an event, an issue, a problem, or other suitable types of occurrences. Details of performing the machine learning are described above in more detail with reference to FIG. 3. The process 200 can then include parsing the decision tree to identify one or more common subsets of attributes most closely related to the event, issue, problem, or occurrence at stage 206. Example operations of parsing the decision tree are described in more detail below with reference to FIG. 4B. The process 200 can further include adjusting at least one value of the common subset of attributes to at least reduce a chance of occurrence of the event at stage 208.

As shown in FIG. 4B, example operational of parsing the decision tree can include inspecting a pair of branches in the decision tree at stage 212. The example operations can then include a decision stage 214 to determine whether the pair of branches share a common subset of attributes. In response to determining that the pair of branches do not share a common subset, the operations revert to inspecting additional branches at stage 212. In response to determining that the pair of branches share a common subset, the operations proceed to removing uncommon attribute(s) from the branches to generate a common subset at stage 216. The operations can further include a decision stage 217 to determine whether the combined probability of the branches exceed a threshold. In response to determining that the combined probability of the branches exceed the threshold, the operations include another decision stage 218 to determine whether additional branches exist in the decision tree. In response to determining that no more branches exist in the decision tree, the operations include outputting the common subset of attributes at stage 220. Otherwise, the operations revert to inspecting additional branches in the decision tree at stage 212.

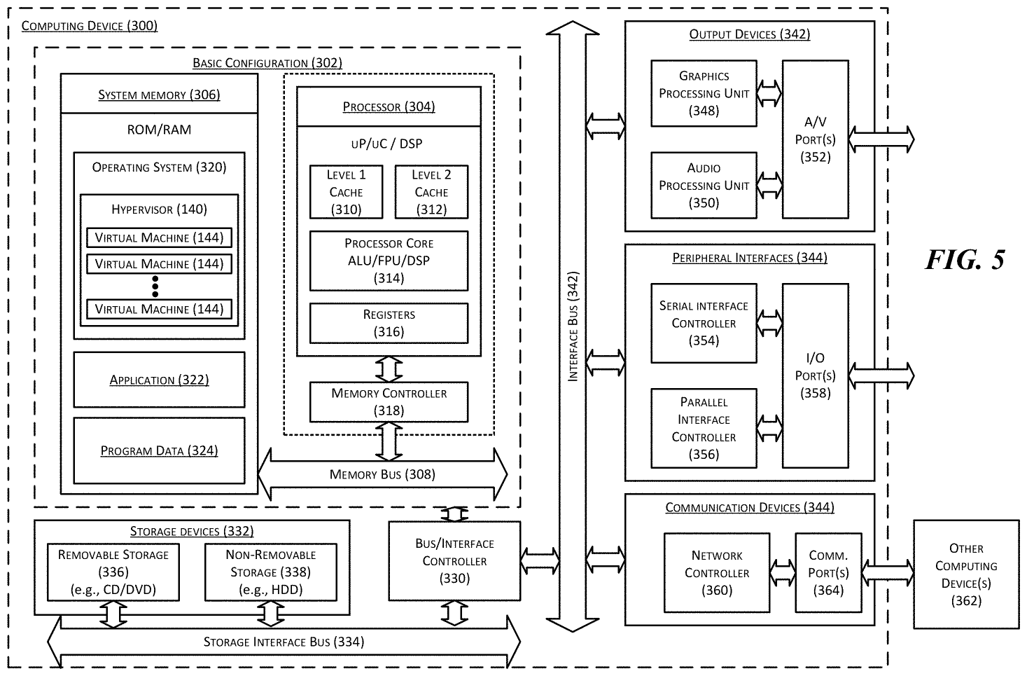

FIG. 5 is a computing device 300 suitable for certain components of the distributed computing system 100 in FIG. 1. For example, the computing device 300 can be suitable for the hosts 106, the client devices 102, or the system performance monitor 125 of FIG. 1. In a basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. As shown in FIG. 5, the operating system 320 can include a hypervisor 140 for managing one or more virtual machines 144. This described basic configuration 302 is illustrated in FIG. 6 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable, and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information, and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more NV ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for contextual data analysis in a distributed computing system having multiple servers interconnected by a computer network, the method comprising:
receiving, at a server in the distributed computing system, operational data and attribute data representing attributes of multiple components in the distributed computing system; and
in response to receiving the data, at the server,
generating a decision tree based on the received operational and attribute data via machine learning, the decision tree having a root and multiple branches each representing a set of the attributes in the attribute data and a corresponding probability value representing a likelihood that one of the multiple components with the set of the attributes would be associated with an event in the distributed computing system;
parsing the multiple branches of the generated decision tree to identify a common subset of the attributes of the multiple components as most closely related to an occurrence of the event in the distributed computing system; and
upon receiving an authorization, adjusting at least one value of the common subset of the attributes to reduce a chance of occurrence of the event in the distributed computing system.

2. The method of claim 1 wherein generating the decision tree includes forming multiple branches on the root of the decision tree based on different values of one of the multiple attributes.

3. The method of claim 1 wherein generating the decision tree includes:
forming multiple first level branches on the root of the decision tree based on different values of a first one of the multiple attributes; and
forming multiple second level branches on each of the first level branches based on different values of a second one of the multiple attributes.

4. The method of claim 1 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes share at least one common attribute, indicating the common subset contains the at least one common attribute.

5. The method of claim 1 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes do not share at least one common attribute, indicating no common subset exist between the first set of attributes and the second set of attributes.

6. The method of claim 1 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes do not share at least one common attribute,
indicating no common subset exist between the first set of attributes and the second set of attributes;
determining whether at least one additional branch exists in the decision tree; and
in response to determining that at least one additional branch exists in the decision tree, inspecting the at least one additional branch to determine whether the at least one additional branch share at least one attribute with the first or second set of attributes.

7. The method of claim 1 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes share at least one common attribute,
indicating the common subset contains the at least one common attribute;
determining whether at least one additional branch exists in the decision tree; and
in response to determining that at least one additional branch exists in the decision tree, inspecting the at least one additional branch to determine whether the common subset shares at least one attribute with the at least one additional branch.

8. The method of claim 1 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes share at least one common attribute,
indicating the common subset contains the at least one common attribute;
determining whether at least one additional branch exists in the decision tree; and
in response to determining that no more additional branch exists in the decision tree, outputting the common subset of the attributes of the multiple components as most closely related to an occurrence of the event in the distributed computing system.

9. The method of claim 1 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes share at least one common attribute,
indicating the common subset contains the at least one common attribute;
determining whether at least one additional branch exists in the decision tree;
in response to determining that at least one additional branch exists in the decision tree, inspecting the at least one additional branch to determine whether the common subset shares at least one attribute with the at least one additional branch; and
repeating the determining whether at least one additional branch exists in the decision tree and inspecting the at least one additional branch until the common subset contains a threshold number of the attributes.

10. A computing device connectable to other computing devices in a distributed computing system by a computer network, comprising:
a processor; and
a memory operatively coupled to the processor, the memory containing instructions executable by the processor to cause the computing device to:
upon receiving operational data and attribute data representing attributes of multiple components in the distributed computing system,
generate a decision tree based on the received operational and attribute data via machine learning, the decision tree having a root and multiple branches each representing a set of the attributes in the attribute data and a corresponding probability value representing a likelihood that one of the multiple components with the set of the attributes would be associated with an event in the distributed computing system;
parse the multiple branches of the generated decision tree to identify a common subset of the attributes of the multiple components as most closely related to an occurrence of the event in the distributed computing system; and
upon receiving an authorization, adjust at least one value of the common subset of the attributes to reduce a chance of occurrence of the event in the distributed computing system.

11. The computing device of claim 10 wherein to generate the decision tree includes to:
form multiple first level branches on the root of the decision tree based on different values of a first one of the multiple attributes; and
form multiple second level branches on each of the first level branches based on different values of a second one of the multiple attributes.

12. The computing device of claim 10 wherein to parse the multiple branches includes to:
inspect first and second branches of the decision tree, the first and second branches corresponding to a first set of attributes and a second set of attributes, respectively;
determine whether the first set of attributes and the second set of attributes share at least one common attribute; and
in response to determining that the first set of attributes and the second set of attributes share at least one common attribute, indicate the common subset contains the at least one common attribute.

13. The computing device of claim 10 wherein to parse the multiple branches includes to:
inspect first and second branches of the decision tree, the first and second branches corresponding to a first set of attributes and a second set of attributes, respectively;
determine whether the first set of attributes and the second set of attributes share at least one common attribute; and
in response to determining that the first set of attributes and the second set of attributes do not share at least one common attribute, indicate no common subset exist between the first set of attributes and the second set of attributes.

14. The computing device of claim 10 wherein to parse the multiple branches includes to:
inspect first and second branches of the decision tree, the first and second branches corresponding to a first set of attributes and a second set of attributes, respectively;
determine whether the first set of attributes and the second set of attributes share at least one common attribute; and
in response to determining that the first set of attributes and the second set of attributes share at least one common attribute,
indicate the common subset contains the at least one common attribute;
determine whether at least one additional branch exists in the decision tree; and
in response to determining that at least one additional branch exists in the decision tree, inspect the at least one additional branch to determine whether the common subset shares at least one attribute with the at least one additional branch.

15. The computing device of claim 10 wherein to parse the multiple branches includes to:
inspect first and second branches of the decision tree, the first and second branches corresponding to a first set of attributes and a second set of attributes, respectively;
determine whether the first set of attributes and the second set of attributes share at least one common attribute; and
in response to determining that the first set of attributes and the second set of attributes share at least one common attribute,
indicate the common subset contains the at least one common attribute;
determine whether at least one additional branch exists in the decision tree; and
in response to determining that no more additional branch exists in the decision tree, output the common subset of the attributes of the multiple components as most closely related to an occurrence of the event in the distributed computing system.

16. The computing device of claim 10 wherein to parse the multiple branches includes to:
inspect first and second branches of the decision tree, the first and second branches corresponding to a first set of attributes and a second set of attributes, respectively;
determine whether the first set of attributes and the second set of attributes share at least one common attribute; and
in response to determining that the first set of attributes and the second set of attributes share at least one common attribute,
indicate the common subset contains the at least one common attribute;
determine whether at least one additional branch exists in the decision tree;
in response to determining that at least one additional branch exists in the decision tree, inspect the at least one additional branch to determine whether the common subset shares at least one attribute with the at least one additional branch; and
repeat the determining whether at least one additional branch exists in the decision tree and inspecting the at least one additional branch until the common subset contains a threshold number of the attributes.

17. A method for contextual data analysis in a distributed computing system having multiple servers interconnected by a computer network, the method comprising:
receiving, at a server in the distributed computing system, operational data and attribute data representing attributes of multiple entities in the distributed computing system; and
in response to receiving the data, at the server,
generating a decision tree based on the received operational and attribute data via machine learning, the decision tree having a root and multiple branches each representing a set of the attributes in the attribute data and a corresponding probability value representing a likelihood that one of the multiple components with the set of the attributes would be associated with an event in the distributed computing system; and
parsing the multiple branches of the generated decision tree to identify a common subset of the attributes of the multiple components as most closely related to an occurrence of the event in the distributed computing system.

18. The method of claim 17 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes share at least one common attribute,
indicating the common subset contains the at least one common attribute;
determining whether at least one additional branch exists in the decision tree; and
in response to determining that at least one additional branch exists in the decision tree, inspecting the at least one additional branch to determine whether the common subset shares at least one attribute with the at least one additional branch.

19. The method of claim 17 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes share at least one common attribute,
indicating the common subset contains the at least one common attribute;
determining whether at least one additional branch exists in the decision tree; and
in response to determining that no more additional branch exists in the decision tree, outputting the common subset of the attributes of the multiple components as most closely related to an occurrence of the event in the distributed computing system.

20. The method of claim 17 wherein parsing the multiple branches includes:
inspecting first and second branches of the decision tree, the first and second branches corresponding to a first set of attributes and a second set of attributes, respectively;
determining whether the first set of attributes and the second set of attributes share at least one common attribute; and
in response to determining that the first set of attributes and the second set of attributes share at least one common attribute,
indicating the common subset contains the at least one common attribute;
determining whether at least one additional branch exists in the decision tree;
in response to determining that at least one additional branch exists in the decision tree, inspecting the at least one additional branch to determine whether the common subset shares at least one attribute with the at least one additional branch; and
repeating the determining whether at least one additional branch exists in the decision tree and inspecting the at least one additional branch until the common subset contains a threshold number of the attributes.
